(19) United States
(12) Patent Application Publication
(10) Pub. No.: US 2011/0135782 A1
(43) Pub. Date: Jun. 9, 2011

(54) NUTRITIOUS FLOATING FISH FOOD

(76) Inventor: Thomas D. Holder, Westminster, CA (US)

(21) Appl. No.: 12/630,787

(22) Filed: Dec. 3, 2009

(51) Int. Cl. A23K 1/18

(52) U.S. Cl. 426/1

(57) ABSTRACT

A floating fish food composition is described that comprises kibble and freeze-dried fruits and vegetables.

### BACKGROUND OF THE INVENTION

The present invention generally relates to nutritious floating fish food, and more particularly relates to floating fish food that provides a completely balanced diet of fruits and vegetables together with basic kibble ingredients.

Currently, food for feeding koi or goldfish generally need to be heated to a high temperature during manufacture to cause the food to float to the surface of a pond. Because such heating during the manufacturing process may lower the nutritional value of such foods, koi and goldfish owners need to feed additional fruits and vegetables to their fish to ensure that their fish has a proper nutritional diet.

As can be seen, there is a need for floating fish food that provides the necessary nutrients to ensure a complete and highly nutritional holistic diet for koi and goldfish.

### SUMMARY OF THE INVENTION

In one aspect of the present invention, a floating fish food composition comprises: kibble; and freeze-dried fruits and vegetables.

In another aspect of the present invention, a method comprises: providing kibble; providing freeze-dried fruits and vegetables; and mixing the kibble and the freeze-dried fruits and vegetables to produce a floating fish food composition.

These and other features, aspects and advantages of the present invention will become better understood with reference to the following drawings, description and claims.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provides nutritious floating food for fish, such as food for koi or goldfish, that may comprise a mixture of standard kibble together with freeze-dried fruits and vegetables.

In accordance with an embodiment of the present invention, a standard kibble may be a fishmeal-based kibble that floats on water and may be mixed together with one or more human-grade freeze-dried fruits and vegetables.

In one exemplary embodiment, the standard kibble may comprise 38% protein, 6% crude fat, 4% crude fiber, 8% ash, and 7% moisture, and may be 4 millimeters in diameter.

The freeze-dried fruits and vegetables may allow the fish food to float while also providing the necessary nutrition for fish, and may comprise fruits such as strawberries, pineapples, granny smith apples, and bananas, and vegetables such as peas, carrots, cauliflower, and broccoli.

In an exemplary embodiment the ratio of kibble to the freeze-dried fruits and vegetables may be 10 pounds of the kibble to 415 grams of the freeze-dried fruits and vegetables, or approximately 10.93 parts kibble to 1 part freeze-dried fruits and vegetables.

In an exemplary embodiment the composition of the 415 grams of fruits and vegetables per the 10 pounds of kibble may be as follows:

carrots—150 grams;

peas—70 grams;

cauliflower—30 grams;

broccoli—40 grams;

strawberries—40 grams;

pineapple—30 grams;

granny smith apples—20 grams;

bananas—35 grams.

The freeze-dried fruits and vegetables may be measured out according to the ratios and proportions described above and may be mixed together with the ratios and proportions of kibble described above to ensure a uniform mix and then poured into jars having a pressure-sensitive liner that ensures an air-tight fit. The composition of the freeze-dried fruits and vegetables and the kibble may then be used as fish food for feeding fish.

The use of freeze-dried fruits and vegetables may provide several advantages over the use of dehydrated fruits and vegetables: freeze-dried fruits and vegetables may be more nutritionally dense than dehydrated vegetables; freeze-dried fruits and vegetables float on the surface of a pool while generally dehydrated fruits and vegetables may not float; and freeze-dried fruits and vegetables may not stick to the kibble once mixed together, while dehydrated fruits and vegetables may be sticky and may not mix well with the kibble.

It should be understood, of course, that the foregoing relates to exemplary embodiments of the invention and that modifications may be made without departing from the spirit and scope of the invention as set forth in the following claims.

We claim:

1. A floating fish food composition comprising:
kibble; and
freeze-dried fruits and vegetables.

2. The floating fish food composition of claim 1, wherein the freeze-dried fruits and vegetables further comprise one or more of carrots, peas, cauliflower, broccoli, strawberries, pineapples, apples, and bananas.

3. The floating fish food composition of claim 1, wherein the floating food composition is in proportion to a ratio of ten pounds of the kibble to 415 grams of the freeze-dried fruits and vegetables.

4. The floating fish food composition of claim 1, wherein the kibble comprise a fishmeal-based kibble.

5. The floating fish food composition of claim 3, wherein the 415 grams of the freeze-dried fruits and vegetables consists of:
150 grams of carrots;
70 grams of peas;
30 grams of cauliflower;
40 grams of broccoli;
40 grams of strawberries;
30 grams of pineapples;
20 grams of apples; and
35 grams of bananas.

6. A method comprising:
providing kibble;
providing freeze-dried fruits and vegetables; and
mixing the kibble and the freeze-dried fruits and vegetables to produce a floating fish food composition.

7. The method of claim 6, wherein the freeze-dried fruits and vegetables further comprise one or more of carrots, peas, cauliflower, broccoli, strawberries, pineapples, apples, and bananas.

8. The method of claim 6, wherein the floating fish food composition is in proportion to a ratio of ten pounds of the kibble to 415 grams of the freeze-dried fruits and vegetables.

9. The method of claim 6, wherein the kibble comprise a fishmeal-based kibble.

10. The method of claim 8, wherein the 415 grams of the freeze-dried fruits and vegetables consists of:
150 grams of carrots;
70 grams of peas;
30 grams of cauliflower;
40 grams of broccoli;
40 grams of strawberries;
30 grams of pineapples;
20 grams of apples; and
35 grams of bananas.
